(19) United States
(12) Patent Application Publication
(10) Pub. No.: US 2020/0100473 A1
(43) Pub. Date: Apr. 2, 2020

(54) AUTOMATED DEVICE AND/OR SYSTEM FOR CULTIVATING MARINE SPECIES

(71) Applicant: Maritime Applied Physics Corporation, Baltimore, MD (US)

(72) Inventors: Mark S. Rice, Brinklow, MD (US); Thomas Woodwerth Bein, Charlottesville, VA (US)

(21) Appl. No.: 16/588,981

(22) Filed: Sep. 30, 2019

Related U.S. Application Data
(60) Provisional application No. 62/824,920, filed on Mar. 27, 2019.
(60) Provisional application No. 62/739,831, filed on Oct. 1, 2018.

(51) Int. Cl. A01K 61/60; A01K 63/04

(52) U.S. Cl. CPC A01K 61/60; A01K 63/042; A01K 63/047

(57) ABSTRACT

A device for cultivating marine species is described. The device includes a structure, a buoyancy device coupled to the structure, a panel coupled to the structure, and an assembly coupled to the structure. The panel is configured to capture solar energy. The assembly includes a support frame, a first sprocket coupled to the support frame, a first motor coupled first sprocket, a first chain coupled to the first sprocket, and a container coupled to the chain. The container is configured to store marine species. The container is configured to be moved by the first motor. The device may include a cleaning device. The device may include an aerating device. The device may include a computing device and an energy storage device. The energy storage device may be coupled to the computing device and the panel.

### CROSS-REFERENCE/CLAIM OF PRIORITY TO RELATED APPLICATIONS

The present application claims priority to and the benefit of U.S. Provisional Application No. 62/739,831, filed on Oct. 1, 2018, and entitled, “AUTOMATED DEVICE AND/OR SYSTEM FOR CULTIVATING MARINE SPECIES”. The present application also claims priority to and the benefit of U.S. Provisional Application No. 62/824,920, filed on Mar. 27, 2019, and entitled, “AUTOMATED DEVICE AND/OR SYSTEM FOR CULTIVATING MARINE SPECIES”. All of the above-mentioned applications are hereby expressly incorporated by reference.

### FIELD

Various features relate to a marine species cultivating device and/or system.

### BACKGROUND

Marine species, such as the bivalve mollusks (including oysters), provide great benefit to the waterways in which they live by filtering as much as 50 gallons of water a day per mollusk. As a result, large populations of species such as oysters can aid in cleaning the waterways. However, cultivating and harvesting mollusks is a process that requires a lot of human labor. This is especially true for large numbers of mollusks. As such, due to the costs involved with using human labor and the time that it takes, cultivating and harvesting mollusks on a large scale, can be a very expensive endeavor. In many instances, it may not be economically viable to predominantly use human labor, to cultivate and harvest some species of mollusks.

As such, there is a need for an automated method, device and/or system that can provide for the cultivating and harvesting of marine species, such as oysters, in a manner that reduces and minimizes human labor. Such a method, device and/or system may enable large numbers of mollusks to be raised, harvested, and sold as food and/or other purposes in an enterprise that is economically viable.

### SUMMARY

Various features relate to a device for cultivating marine species, and more specifically to an automated device and/or system for cultivating marine species.

An example provides an apparatus for cultivating marine species. The apparatus includes means for supporting the apparatus over a surface of the water; means for providing water permeable containers for holding marine species; and means for moving the water permeable containers so that debris may be flushed from the water permeable containers.

Another example provides a device for cultivating marine species. The device includes a structure, a buoyancy device coupled to the structure, a panel coupled to the structure, and an assembly coupled to the structure. The panel is configured to capture solar energy. The assembly includes a support frame and a container configured to store marine species, wherein the container is configured to be moveable.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates an exemplary automated device for cultivating mollusks.

FIG. 2 illustrates an exemplary rearing container for the automated device for cultivating mollusks.

FIG. 3 illustrates an exemplary support assembly and rearing containers for the automated device for cultivating mollusks.

FIG. 4 (which includes FIGS. 4A-4C) illustrates an exemplary sequence of an automated device for cultivating mollusks moving the rearing containers.

FIG. 5 illustrates an exemplary automated device for cultivating mollusks in a configuration for winter conditions.

FIG. 6 illustrates an exemplary automated device for cultivating mollusks in a configuration for summer conditions.

FIG. 7 illustrates an exemplary automated device for cultivating mollusks in a configuration for hurricane conditions.

FIG. 8 illustrates an exemplary automated device for cultivating mollusks in a configuration for maintenance.

FIG. 9 illustrates a close-up view of an exemplary automated device for cultivating mollusks.

FIG. 10 illustrates another view of an exemplary automated device for cultivating mollusks.

FIG. 11 illustrates an exemplary power source for an automated device for cultivating mollusks.

FIG. 12 illustrates an exemplary support assembly and rearing containers for the automated device for cultivating mollusks.

FIG. 13 illustrates an exemplary automated device for cultivating mollusks that includes a propulsion device.

FIG. 14 illustrates an exemplary close up view of the support assembly and rearing containers for the automated device for cultivating marine species, where the support assembly includes a device for rotating the rearing containers.

FIG. 15 illustrates an exemplary close up view of the support assembly and rearing containers for the automated device for cultivating marine species, where the support assembly includes a device for rotating the rearing containers.

FIG. 16 illustrates a view of an exemplary device configured for cultivating marine species.

FIG. 17 illustrates a profile view of an exemplary device configured for cultivating marine species.

FIG. 18 illustrates a top plan view of an exemplary device configured for cultivating marine species.

FIG. 19 illustrates another profile view of an exemplary device configured for cultivating marine species.

FIG. 20 illustrates various components of a controller for an automated device for cultivating mollusks.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The present disclosure describes a device for cultivating marine species. The device includes a structure, a buoyancy device coupled to the structure, a panel coupled to the structure, and an assembly coupled to the structure. The panel is configured to capture solar energy. The assembly includes a support frame, and a container configured to store marine species, wherein the container is configured to be moveable. In one or more implementations, the assembly may include a support frame, a first sprocket coupled to the support frame, a first motor coupled first sprocket, a first chain coupled to the first sprocket, and a container coupled to the chain. The container is configured to store marine species. The container is configured to be moved by the first motor. The device may include a cleaning device. The device may include an aerating device. The device may include a computing device and an energy storage device. The energy storage device may be coupled to the computing device and the panel.

### Exemplary Device for Cultivating Marine Species

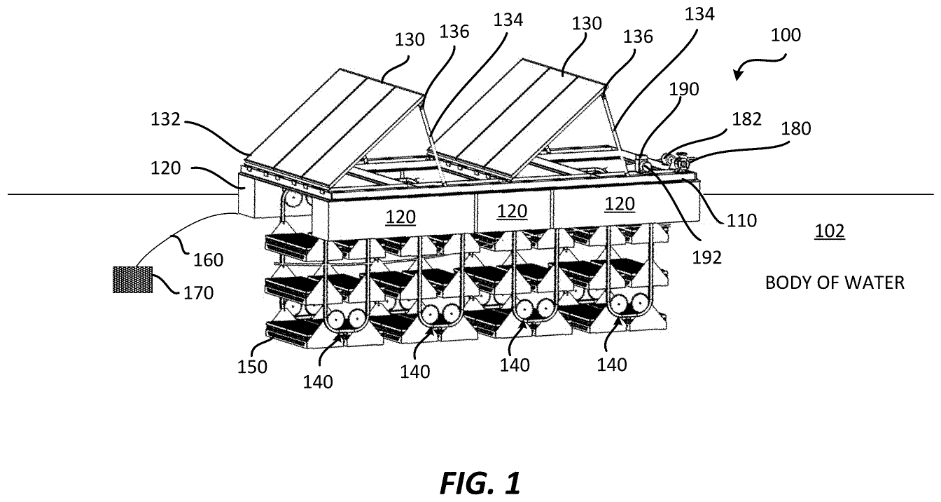

FIG. 1 illustrates an exemplary device 100 for cultivating marine species, such as oysters. The device 100 may be an automated marine species cultivating device. The device 100 may provide an automated process for cultivating and/or harvesting marine species. The device 100 may operate in a body of water 102, such as a water stream, a waterway, a river, a lake, and an ocean. The body of water 102 may be a human made body of water or a natural body of water. The device 100 may be implemented as a platform (e.g., floating platform). In some implementations, the device 100 may be implemented as part of a vessel, a ship, a catamaran and/or a water borne vehicle.

As shown in FIG. 1, the device 100 includes a structure 110, one or more buoyancy devices 120 (e.g. buoyant float, first buoyancy device, second buoyancy device), one or more panels 130, and one or more assemblies 140 (e.g., first assembly, second assembly). As will be further described below, marine species, such as oysters, may be cultivated (e.g., grown) in the one or more assemblies 140. More specifically, marine species may be cultivated in one or more containers 150 of the assemblies 140. The buoyancy devices 120, the panels 130 and the assemblies 140 are coupled to the structure 110. The structure 110 (e.g., support structure, vessel structure) may include one or more frames, beams, joints, and/or compartments that provide structural support for the device 100. FIG. 1 illustrates one example of a structure 110 for the device 100. However, different implementations may provide a structure 110 with different shapes and/or sizes. In addition, different implementations may use different materials for the structure 110.

The one or more buoyancy devices 120 are means for providing buoyancy for the device 100. A buoyancy device 120 may have the same shape, a similar shape or a different shape than another buoyancy device 120. One or more of the buoyancy devices 120 may be an inflatable buoyancy device. In some implementations, the buoyancy devices 120 are configured in such a way that at least part of the assemblies 140 are submerged in the body of water 102. For example, the size, shape, configuration, material(s) and/or position of the buoyancy devices 120 may be selected so that part of the assembly 140 is submerged in the body of water 102 while other parts of the assembly 140 are above the body of water 102. FIG. 1 illustrates that the buoyancy devices 120 are located on opposite sides of the structure 110.

The panels 130 (e.g., first panel, second panel, third panel) are coupled to the structure 110. The panels 130 may include a panel frame and solar panels for harvesting energy (e.g., solar energy), which can be used to provide power for the device 100. Thus, the panels 130 may provide a source of energy (e.g., renewable energy) for the device 100. The panels may be means for providing and/or harvesting solar energy. The solar panels may include photovoltaic solar panels. The solar panels may be coupled to an energy storage device (e.g., battery), a computing device (e.g., controller) and/or any other device that may operate on electric power. Each of the panels 130 may be moveable relative to the structure 110. For example, each panel 130 may rotate about a point of the structure 110; each panel 130 may slide along the structure 110; each panel may pivot about the structure 110; or combinations thereof.

FIG. 1 illustrates that each panel 130 may be coupled to the structure 110 through a hinge 132, a leg 134 and a pin 136. However, other mechanisms may be used to couple the panel 130 to the structure 110. Each panel 130 may pivot about a hinge 132. The leg 134 may be coupled to a portion of the panel 130 through the pin 136. The leg 134 may position the panel 130 at a certain angle and/or position. The panels 130 may be moved manually. However, a motorized device and/or system may be used to move the leg(s) 134, which in turn move the panel(s) 130. For example, a motor (e.g., electric motor) coupled to sprockets and a chain may be used to move the leg 134, which would effectively move and/or pivot the panel 130. The panels 130 may be moved and/or positioned in such a way that the panels 130 are pointed towards the sun to get the most direct light. In some implementations, the panels 130 may be moved to follow the path of the sun. A computing device may be used to control movement and/or alignment of the panels 130.

FIG. 1 also illustrates the assemblies 140. As mentioned above, the assemblies 140 may be configured to store and move the marine species, such as oysters. Each assembly 140 may include one or more containers 150 (e.g., rearing containers). These containers 150 can be moved by the device 100 in such a way that the containers 150 can be submerged (e.g., partially submerged, fully submerged) in the body of water 102 or be positioned outside of the body of water 102. The containers 150 can be an open container and/or a container that can be enclosed. The containers 150 may be made of a porous material and/or water permeable material that may allow water to flow in and out of the containers 150. The containers 150 may include gaps, cavities, orifices and/or holes that allow water to flow in and out of the containers 150. For example, the containers 150 may include a mesh (e.g., metallic mesh, non-metallic mesh). The mesh may be of sufficient strength to prevent the teeth or claws of predators, such as fish or crabs, from gaining access to the interior of the containers 150. The marine species (e.g., oysters) may be placed on and/or inside the containers 150, thereby providing a space for the marine species to grow. The assembly 140 may be a means for moving containers. The container 150 may be a means for storing marine species. The assembly 140 and the container 150 will be further described below.

The device 100 may also include a cleaning device (e.g., means for cleaning) that includes a pump 180 and a motor 182 (e.g., electric motor, second motor, third motor). The cleaning device may be used to clean one or more of the containers 150 in an automated manner. The cleaning device (which includes the pump 180 and the motor 182) may be coupled to the structure 110, the buoyancy devices 120, the panels 130, and/or the assemblies 140. Different implementations may position the cleaning device in different locations. In some implementations, there may be more than one cleaning device.

The pump 180 may be a water pump. The motor 182 may drive the pump 180 to pump water from the body of water 102, which in turns sprays the containers 150 with the water. Rails and/or tubes may be used to direct the pumped water towards the containers 150. Cleaning the containers 150 and/or the mollusks inside the containers 150 using the cleaning device will be further described in detail below.

The device 100 may also include an aerating device (e.g., means for aerating) that includes a blower 190 and a motor 192 (e.g., electric motor, second motor, third motor). The aerating device is configured to inject air into a portion of the body of water 102 that is near or includes the containers 150. The blower 190 may be an air pump that is driven by the motor 192 to take air from the environment and inject the air in the body of water 102. This may help with providing a more ideal or optimal environment for the marine species that are being cultivated by the device 100. The use of the aerating device will be further described in detail below.

The device 100 may also include lines 160 (e.g., mooring lines) coupled to one or more anchors 170. The lines 160 may be coupled to the structure 110, the buoyancy devices 120, the panels 130, and/or the assemblies 140. The lines 160 and the anchors 170 may help position and moor the device 100 on the surface of the body of water 102. The anchors 170 may be located at the bottom of the body of water 102.

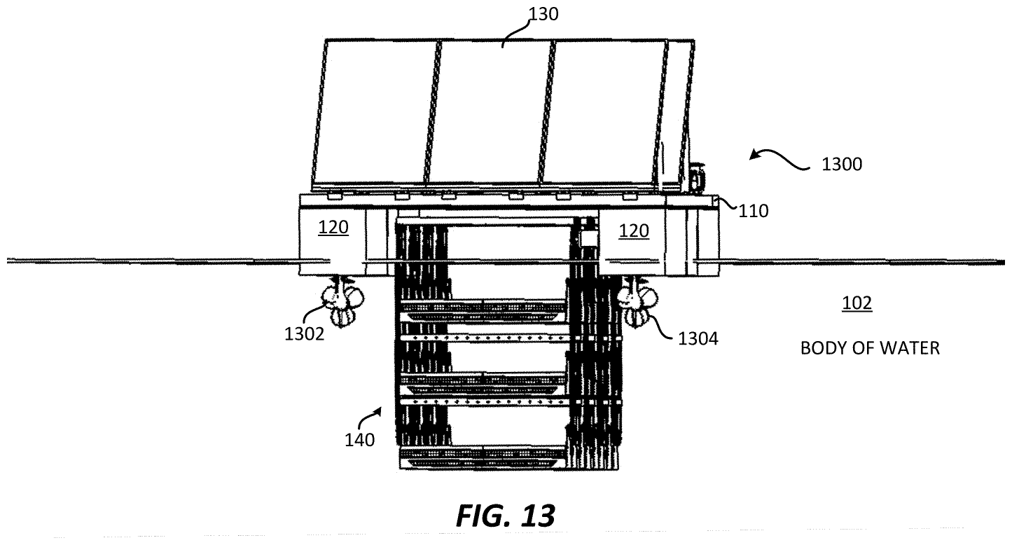

In some implementations, the device 100 can be moved in the body of water 102 through one or more propulsion device(s). An example of a device that includes a propulsion device will be further described in FIG. 13.

The device 100 may include other components, such as computing devices, energy storage devices, one or more sensors, communication devices, and/or antennas (which are not visible in FIG. 1). These computing devices, energy storage devices, one or more sensors, communication devices and/or antennas may be coupled to the structure 110. In some implementations, some or all of these computing devices, energy storage devices, one or more sensors, communication devices and/or antennas may be located inside one or more compartments that are coupled to the structure 110 and/or part of the structure 110. Some or all of these computing devices, energy storage devices, one or more sensors, communication devices and/or antennas may be implemented in other parts of the device 100, such as the buoyancy devices 120, the panels 130 and/or the assemblies 140.

The above components of the device 100 allow the device 100 to provide an automated process for cultivating and/or harvesting marine species (e.g., oysters) in a manner that optimizes growth conditions, while also reducing and/or minimizing human labor associated with maintaining the device 100. While oysters are used as an example of a marine species that can be cultivated and/or harvested by the device 100, other types of marine species may be cultivated and/or harvested in the device 100.

### Exemplary Assembly and Containers for Storing Marine Species

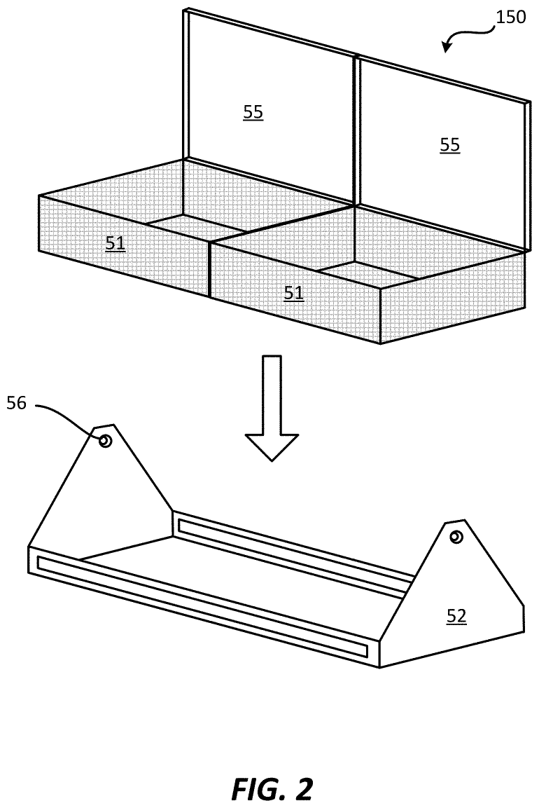

FIG. 2 illustrates a close-up view of the container 150 that can be implemented by the assembly 140. In some implementations, a plurality of containers 150 may be coupled to each assembly 140. The number of containers 150 (e.g., rearing containers) may vary for the assembly 140. As mentioned above the container 150 may be configured to hold and/or store the marine species (e.g., oysters) as the marine species grows.

The container 150 includes a bottom container 51 and a lid 55 (e.g., container lid). The lid 55 may be coupled to the bottom container 51 to provide an enclosed space for the marine species. For example, one or more marine species may be placed in the bottom container 51 and the lid 55 is provided over the bottom container 51 to enclose the marine species. The bottom container 51 and/or the lid 55 may be made of a porous material which may allow water (which may include nutrients) from body of water 102 to enter and leave the container 150. In some implementations, the bottom container 51 and/or the lid 55 may include small (e.g., micro, tiny) gaps, spaces, cavities and/or holes that could allow water to enter and leave the container 150. The bottom container 51 includes several walls and/or partitions that allow one more marine species to be placed in the container 150. The bottom container 51 may be placed into the container frame 52. The size and shape of the container 150 may vary. Different implementations may use different materials for the bottom container 51 and/or the lid 55. For example, a material that is resistant to rust may be used. In some implementations, one or more materials (e.g., stainless steel) that are strong enough to withstand tampering from animals (e.g., predators, seals) may be used. A coupling mechanism (e.g., latch) may be used to couple the lid 55 to the bottom container 51 to ensure that the lid 55 is not inadvertently decoupled from the bottom container 51 during an operation of the device 100. The container frame 52 may include pivots 56 that may be used to couple the container 150 to an assembly 140.

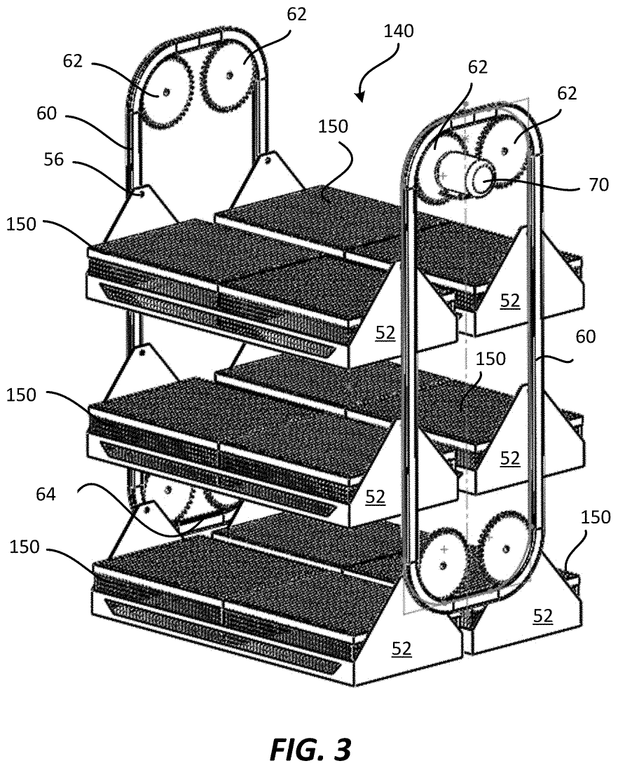

FIG. 3 illustrates an example of an assembly 140 of the device 100. The assembly 140 includes a support frame 60 (e.g., first support frame, second support frame), a plurality of sprocket 62 (e.g., first sprocket, second sprocket), a plurality of chains 64 (e.g., first chain, second chain) and at least one motor 70 (e.g., electric motor, first motor). The assembly 140 may be coupled to the structure 110. For example, the support frame 60 may be coupled to the structure 110. The plurality of containers 150 (e.g., first container, second container, third container, . . . ) is coupled to the assembly 140 through the container frame 52. In particular, the pivots 56 (e.g., first pivot, second pivot) of the container frames 52 (e.g., first container frame, second container frame) may be coupled to the chains 64. The chains 64 are coupled to the sprockets 62. A motor 70 is coupled to a sprocket 62 and may drive the sprocket 62, which may move the chain 64, which then moves the container frame 52 that may be holding the container 150. The chain 64 may move along the support frame 60 (e.g., within the support frame 60). The pivot 56 of the container frame 52 may help ensure that the lid 55 is always facing up. The assembly 140 allows the container 150 to move up, move down, and move laterally. FIG. 3 illustrates one example of an assembly 140. However, different implementations may have different arrangements of the assembly 140, including a support frame 60 with different shapes. The support frame 60 may be made of a single piece or several pieces and/or several components.

Having described an example of an assembly for the device 100, an example of how an assembly may operate will be further described below.

### Exemplary Sequence of a Device Moving Containers

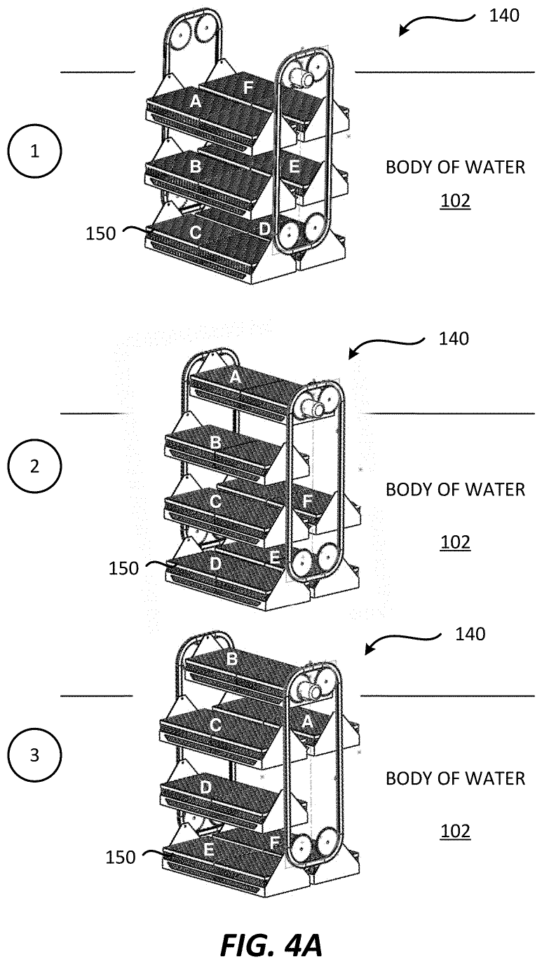

FIG. 4 (which includes FIGS. 4A-4C) illustrates an exemplary sequence of an assembly 140 moving several containers 150. In some implementations, the sequence of FIGS. 4A-4C illustrates the assembly 140 of the device 100 of FIGS. 1 and 3.

It is noted that the sequence of FIGS. 4A-4C may combine one or more stages in order to simplify and/or clarify the sequence shown in FIGS. 4A-4C. In some implementations, the order of the sequence of the operation may be changed or modified. Additional operations may also be added to the sequence. FIGS. 4A-4C illustrate an example of an assembly that includes six containers 150 that are labeled A through F.

Position 1, as show in FIG. 4A, illustrates a position where all the containers 150 (A-F) of the assembly 140 are submerged in water. Submerging the containers 150 has several advantages and/or benefits. First, submergence is necessary for the marine species to grow. Second, submerging the containers 150 below the water surface provides protection from airborne and water surface predators. Third, submerging the containers 150 below the reach of a man increases the level of difficulty and thereby provides a passive deterrent to poaching and/or theft.

Position 2 illustrates a position after the assembly 140 has moved the container frames 52 (which are holding the containers 150) such that container A is above water and containers B-F are submerged. In this position, various activities may be performed on the container A, such as maintenance activities needed to sustain growth (e.g., healthy growth) of the marine species. Examples of activities may include inspection, flushing, filling, culling, and harvesting. Moving the container frames 52 with a motor eliminates the manual effort that would be required to move the container frames 52.

Position 3 illustrates a position after the assembly 140 has moved the container frames 52 (which are holding the containers 150) such that container B is above water and containers A and C-F are submerged. Similarly, as described above, in this position, various activities may be performed on the container B, such as maintenance activities needed to sustain growth (e.g., healthy growth) of the marine species. Examples of activities may include inspection, flushing, filling, culling, and harvesting. Moving the container frames 52 with a motor eliminates the manual effort that would be required to move the container frames 52.

Position 4, as show in FIG. 4B, illustrates a position after the assembly 140 has moved the container frames 52 (which are holding the containers 150) such that container C is above water and containers A-B and D-F are submerged. Similarly, as described above, in this position, various activities may be performed on the container C, such as maintenance activities needed to sustain growth (e.g., healthy growth) of the marine species. Examples of activities may include inspection, flushing, filling, culling, and harvesting. Moving the container frames 52 with a motor eliminates the manual effort that would be required to move the container frames 52.

Position 5 illustrates a position after the assembly 140 has moved the container frames 52 (which are holding the containers 150) such that container D is above water and containers A-C and E-F are submerged. Similarly, as described above, in this position, various activities may be performed on the container D, such as maintenance activities needed to sustain growth (e.g., healthy growth) of the marine species. Examples of activities may include inspection, flushing, filling, culling, and harvesting. Moving the container frames 52 with a motor eliminates the manual effort that would be required to move the container frames 52.

Position 6, as show in FIG. 4C, illustrates a position after the assembly 140 has moved the container frames 52 (which are holding the containers 150) such that container E is above water and containers A-D and F are submerged. Similarly, as described above, in this position, various activities may be performed on the container E, such as maintenance activities needed to sustain growth (e.g., healthy growth) of the marine species. Examples of activities may include inspection, flushing, filling, culling, and harvesting. Moving the container frames 52 with a motor eliminates the manual effort that would be required to move the container frames 52.

Position 7 illustrates a position after the assembly 140 has moved the container frames 52 (which are holding the containers 150) such that container F is above water and containers A-E are submerged. Similarly, as described above, in this position, various activities may be performed on the container F, such as maintenance activities needed to sustain growth (e.g., healthy growth) of the marine species. Examples of activities may include inspection, flushing, filling, culling, and harvesting. Moving the container frames 52 with a motor eliminates the manual effort that would be required to move the container frames 52.

The above sequence may be repeated and/or iterated several times in various orders, including a reversed order. In some implementations, more than one container 150 may be located above the body of water. The movement of the container frame 52 and thus the movement of the containers 150 may be manually controlled by a user operating a motorized device or may controlled (e.g., automatically controlled) by a computing device (e.g., controller) that may move the container frames 52 by controlling the motor 70.

### Exemplary Configurations of the Device

The device 100 may be placed in a body of water 102 for an extended period of time, since marine species such as oysters may take a long time to grow to a point where they can be harvested. As such, the device 100 may be subject to various weather conditions, and will go through various seasonal conditions. As such, the device 100 may have different configurations that allow the device 100 to survive these conditions and operate properly for a long period of time despite these varying conditions.

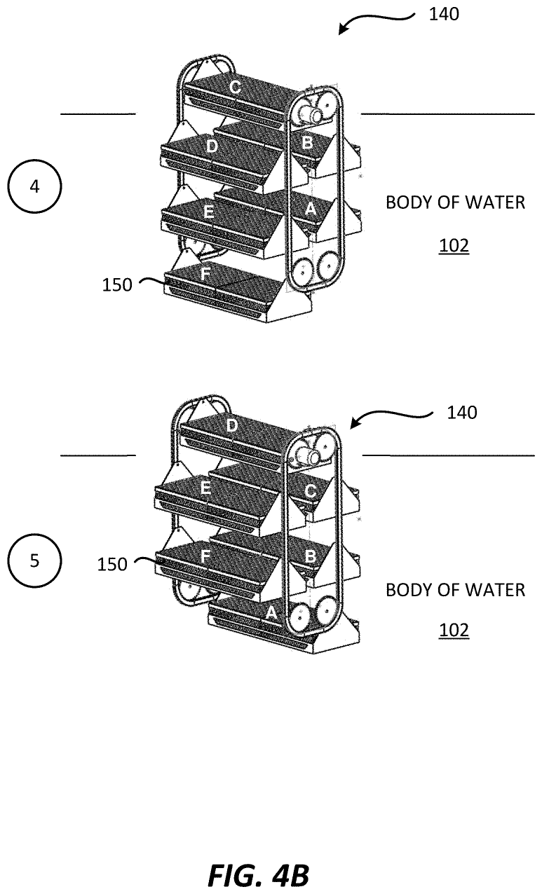

FIGS. 5-8 illustrates 4 possible configurations of the device 100. It is noted that there may be other possible configurations for the device 100. FIG. 5 illustrates a first configuration that is designed for winter conditions when the sun is lower in the horizon. In this configuration, the panels 130 are positioned at an angle that is relatively steeper (e.g., steeper than summer configuration) to ensure that the panels 130 are facing the sun in angle that is as direct as possible.

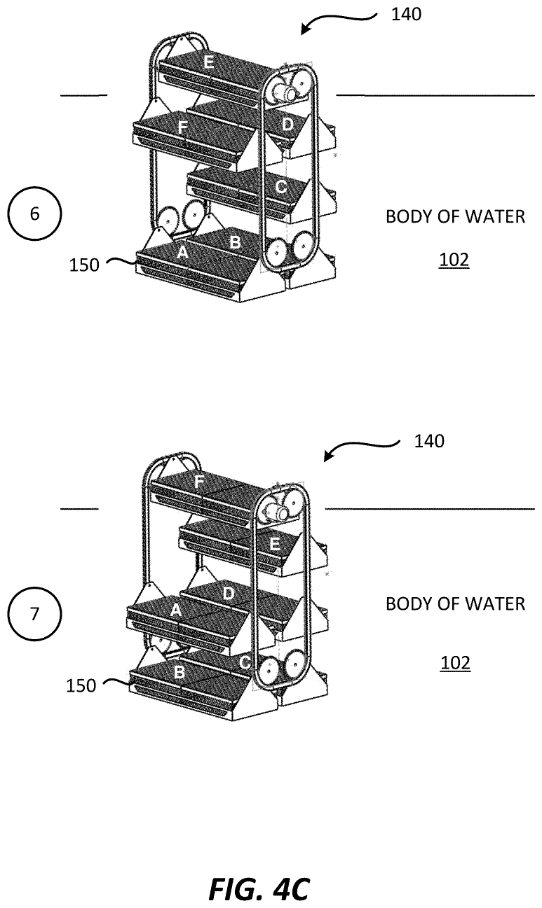

FIG. 6 illustrates a second configuration that is designed for summer conditions when the sun is higher in the horizon. In this configuration, the panels 130 are positioned at an angle that is relatively flatter (e.g., flatter than winter configuration) to ensure that the panels 130 are facing the sun in angle that is as direct as possible.

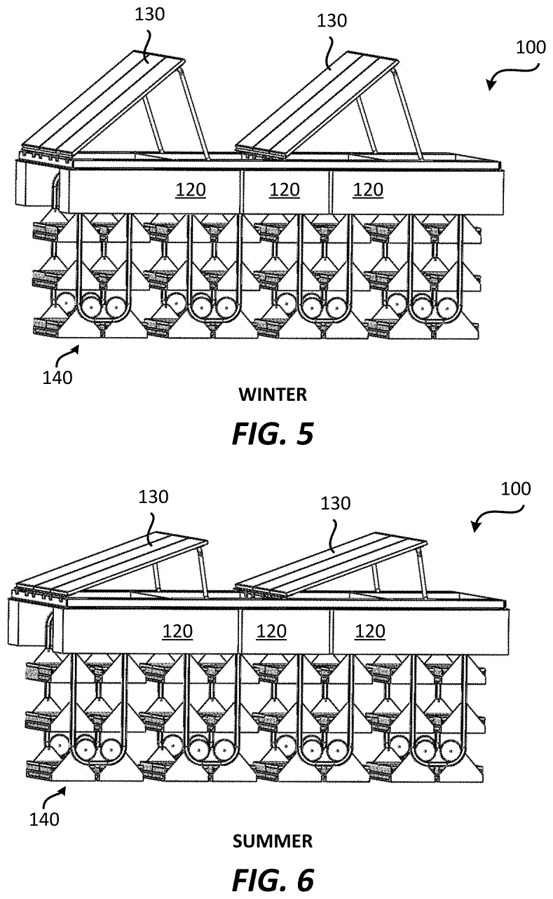

In some instances, conditions may be such that the water is very rough and/or choppy, and winds have picked up quite substantially. This may happen under hurricane conditions. FIG. 7 illustrates a third configuration that is designed for hurricane conditions. In this configuration, the panels 130 have been retracted down such that they are positioned flat over the structure 110. This reduces and/or minimizes the load the panels 130 due to high winds. In some implementations, the panels 130 may be retracted further below the structure 110 (or surrounded by the structure 110) to further protect the panels 130 from the high winds.

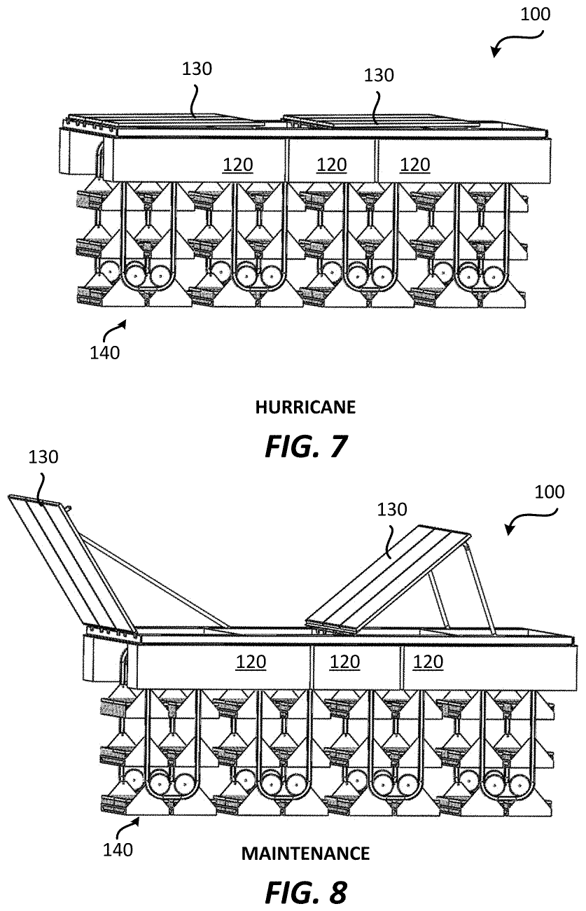

FIG. 8 illustrates a fourth configuration that is designed for accessing the containers 150. In this configuration, the panels 130 have been positioned to open up so that the containers 150 are easily accessible (e.g., accessible by a person). The angles of the panels 130 may vary, such as being open by 120 degrees. However, different implementations may use different angles.

FIGS. 5-8 illustrate some examples of configurations for the device 100. However, it is noted that the device 100 may include other configurations.

### Exemplary Device Comprising a Cleaning Device

As mentioned above, the device 100 may be implemented in a body of water 102. Different bodies of water will have different conditions. Some bodies of water will be cleaner than others, while some will be more polluted than others. Waste products, debris, and marine fouling will accumulate on and in the containers 150. In order to maintain the optimal conditions to grow the marine species, it is important to remove the foreign and undesired materials. For example, these undesired materials may block or prevent water from properly flowing in an out of the containers 150. The high density of marine species, such as oysters in the baskets or containers increases the need for debris removal. However, traditional methods of debris removal are labor intensive and not cost effective.

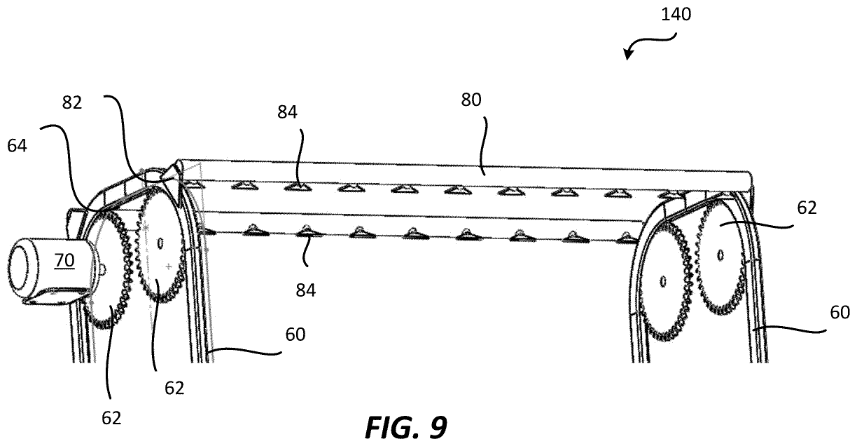

FIG. 9 illustrates an assembly 140 that includes spray rails 80. The spray rails 80 may be part of the support frame 60 or coupled to the support frame 60. In some implementations, the spray rails 80 may be coupled to assembly 140. The spray rails 80 may be coupled to the support frame 60 with brackets 82. The electric motor 182 may drive the pump 180 to pump water from the body of water 102, through the spray rails 80 and out of the nozzles 84, which are directed at the containers 150. In some implementations, the nozzles 84 are stationary (e.g., fixed) and the containers 150 move past the spray nozzles 84 when the containers 150 are traversing about the support frame 60. Although not shown, one or more tubes may couple the spray rails 80 to the pump 180. In some implementations, the pump 180 may get water from the body of water 102 through a tube. In some implementations, the pump 180, the motor 182, the spray rails 80 and the nozzles 84 are part of the cleaning device or mechanism for the device 100. In some implementations, the motor 182 may be implemented as part of the pump 180. Thus, the pump 180 may include the motor 182 in some implementations.

In some implementations, the cleaning device may be configured to clean the containers 150 during pre-determined times. The cleaning device may also be configured to detect when the containers are dirty and clean them. For example, the device 100 may detect that containers are covered with debris and that no water flow, little water flow, or less than the usual amount of water is flowing through the containers 150, which may be an indication that the containers 150 are covered with debris and should be cleaned. Different implementations may use different techniques for detecting when one or more containers are dirty and/or covered with debris.

### Exemplary Device Comprising an Aerating Device

The time required for marine species, such as oysters, to grow from a larvae to an adult requires a consider amount of time, 2 to 3 years, where the shorter time is produced in an ideal environment. Natural oyster growing reefs are predominant in areas where the water is brackish and the water flow is sufficient to remove debris thereby permitting the oyster's access to the nutrients in the water. Growing the marine species, such as oysters, in baskets or containers has the similar need to remove debris from the mollusks. The ideal environment for growing marine species, such as oysters, may require that the percentage of dissolved oxygen be greater than about 5.5 mg/l.

In some implementations, the device 100 may include an aerating device to ensure that the percentage of dissolved oxygen is equal or greater than a desired value (e.g., equal or greater than 5.5 mg/l). A sensor may be used to measure the amount and/or percentage of dissolved oxygen there is in an area of the body of water 102 that includes the containers 150. Data from the sensor may be transmitted to a computing device. In some implementations, whenever the amount and/or percentage of dissolved oxygen drops below a certain value (e.g., 5.5 mg/l), the aerating device may be activated, which then may introduce more oxygen in an area of the body of water that includes the containers 150.

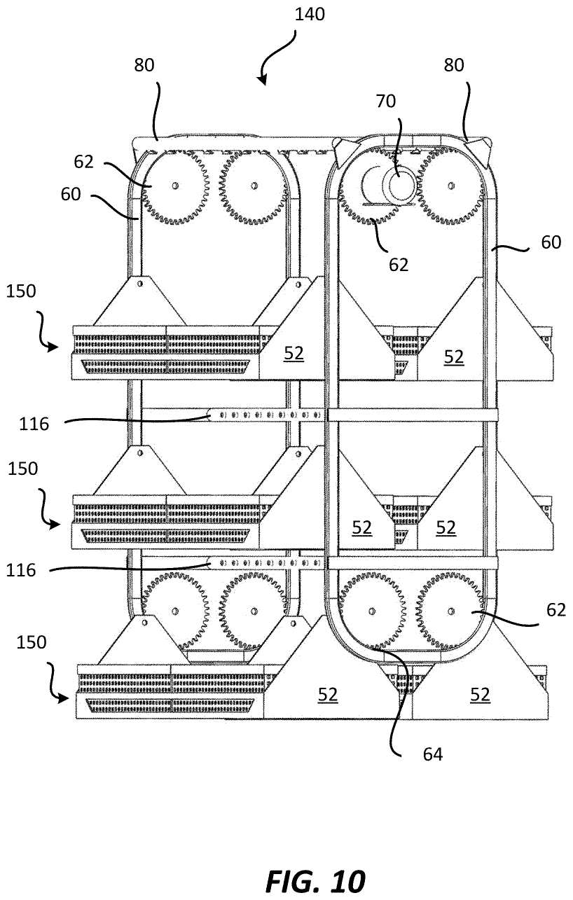

FIG. 10 illustrates an assembly 140 that includes an aerating device. The aerating device may include a blower 190 that is driven by a motor 192 (e.g., electric motor) to inject air into the water through a series of orifices 116 in the support frame 60. In some implementations, the motor 192 may be implemented as part of the blower 190. Thus, the blower 190 may include the motor 192 in some implementations. A tube (e.g., rigid or flexible tube) may be used to couple the blower 190 to the support frame 60. Examples of the blower 190 and the motor 192 are shown in FIG. 1. However, it is noted that the blower 190 and/or the motor 192 may be located in similar and/or different locations of the device 100. The blower 190 may be an air pump, such as an air compressor.

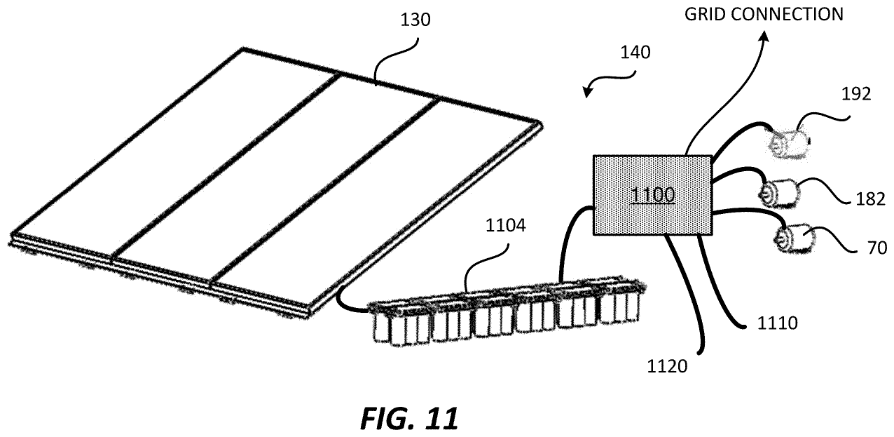

As mentioned above, the device 100 may be powered by the panels 130, which include solar panels. FIG. 11 illustrates the panels 130 coupled to a computing device 1100 and an energy storage device 1104 (e.g., battery). The energy storage device 1104 and the computing device 1100 may be coupled to the motor 70, the motor 182, the motor 192, the sensors 1110, and/or the anti-theft device 1120. As mentioned above, some or all of the mechanical operations of the device 100 may be powered by the energy absorbed by the panels 130 (and/or other energy source(s)) and controlled by a computing device 1100, that manages the operation of the electric motor 70, which moves the containers 150 past the spray nozzles 84, the pump 180, which pumps the water through the spray nozzles 84, and the blower 190, which compresses the air through the orifices 116.

In some implementations, the computing device 1100 may use timers to repeat the flushing cycle as required to provide ideal growing conditions. The computing device 1100 may use sensors 1110 to monitor the water properties and conditions, such as water quality. When the level of dissolved oxygen in the water falls below a set level (e.g., 5.5 mg/l), the computing device 1100 may activate the blower 192 until the levels rise above the set point. The energy from the panels 130 and/or propellers (1302, 1304) may be stored in energy storage device 1104 (e.g., battery) until energy is needed. Excess energy absorbed by the device 100 may be available for other purposes, such as connecting the energy to a land based electrical distribution grid. The energy absorbed by the panels 130 may also be used to power the navigational lights, the surveillance system, and the anti-theft device 1120. The panels 130 may also be used to power a motorized device that can move the panels 130. The device 100 may include other sensors to monitor the surrounding environment, such as a wind sensor.

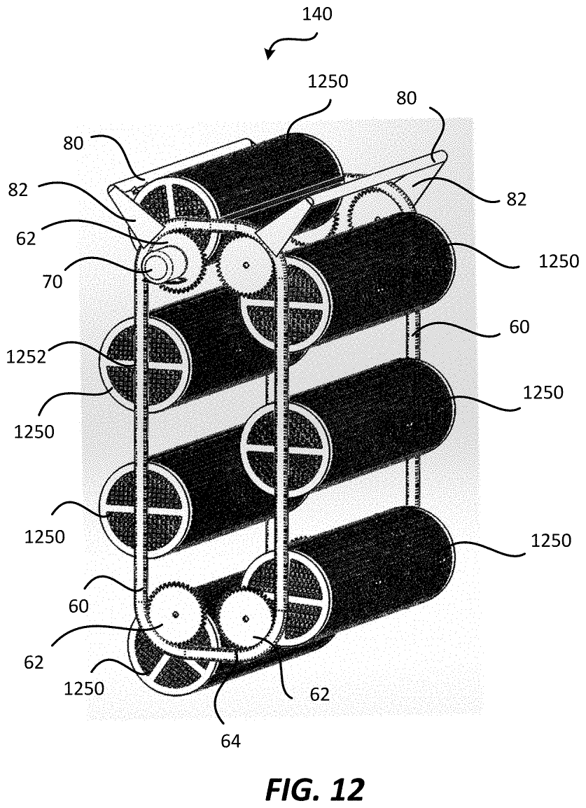

FIGS. 2 and 3 illustrates the shape of the containers 150 as rectangular. However, in some implementations, the containers 150 may have different shapes and/or sizes. FIG. 12 illustrates an assembly 140 that includes containers 1250 with a different shape. In particular, the containers 1250 have a substantially cylindrical shape. This shape may permit rolling the marine species over during the growing process which has been shown to be beneficial for some species, such as oysters. The mechanism to move the containers 1250 around the support frame 60 is substantially similar to that used with the containers 150. In some implementations, the containers 1250 are attached to the support frame 60 so that the containers are rotated through 360 degrees each time they travel around the support frame. Different implementations may couple the containers 1250 to the support frame differently. The containers 1250 may be coupled to one or more chains 64 and may move along with the chain 64, as the chain travels along the support frame 60. In some implementations, each of the containers 1250 is supported along a central axis 1252 of the container 1250 and is free to spin about that axis. The containers 1250 may include a closable door and/or opening that allows objects and/or marine species to be placed or removed from the containers. The closable door of the containers 1205 may be lockable. In some implementations, one or more of the containers 1250 may be coupled to one or more motors (e.g., electric motor). One or more motors may rotate each of the respective containers 1250 about its respective central axis 1252. The one or more motors may be means to rotate the containers.

### Exemplary Device Comprising Propellers

In some implementations, the device 100 may include other components. For example, the device 100 may be moveable through one or more propulsion devices and/or may include other mechanisms for capturing and providing energy (e.g., renewable energy).

FIG. 13 illustrates a device 1300 for cultivating marine species. The device 1300 of FIG. 13 may be similar to the device 100 and may include components that are similar or the same as the device 100 of the present disclosure. configurations, functions, capabilities, operations and/or components that are described for the device 100 may also be applicable to the device 1300. Similarly, configurations, functions, capabilities, operations and/or components that are described for the device 1300 may also be applicable to the device 100. FIG. 13 illustrates that the device 1300 includes a first propeller 1302 and a second propeller 1304. It is noted that the different implementations may have different numbers of propellers, with each propeller being positioned in various locations. For example, one or more of the propellers may be coupled to structure 110 and/or the buoyancy devices 120.

In some implementations, the propellers (1302, 1304) may be used to provide thrust to the device 1300, enabling the device 1300 to move about in the body of water 102. In some implementations, the propellers may be configured to keep the device 1300 as fixed as possible in a body of water that has current. For example, instead of using mooring lines, or in conjunction with using mooring lines, the propellers may be used to keep the device 1300 relatively fixed and/or about a location in a moving current of the body of water. The propellers may be controlled by a computing device. The movement of the device 1300 in the body of water may be controlled by a human through the computer device. In some implementations, the device 1300 may operate autonomously in the body of water 102. The propellers (1302, 1304) may be means for propulsion for the device 1300. In some implementations, instead of a propeller, the device 1300 may use another mechanism for providing thrust to the device 1300.

In some implementations, the propellers (1302, 1304) may be used to capture and harvest energy from the body of water 102. For example, the body of water 102 may include a current or moving water that passes through and/or around the device 1300. The energy from the current or moving water may be captured by the propellers and converted into energy (e.g., electrical energy) that can be stored in an energy storage device and/or be used by components of the device 1300. In such a configuration, the propellers may act as a turbine. For example, when the device 1300 is set in a fixed position by mooring lines, and there is a current in the body of water 102. One or more propellers may be configured to capture and harvest energy from the current, thus providing another source of energy (e.g., renewable energy) for the device 1300. In some implementations, one or more propellers may be rotated in a certain direction (e.g., direction facing the current, direction parallel to the current) in order to optimize and maximize the amount of energy that is captured by the propeller and ultimately by the device 1300. In some implementations, the propellers (1302, 1304) may be means for capturing energy (e.g., capturing motion energy, capturing water motion energy).

Thus, one or more of the propellers may provide more than one functionality. In a first configuration, the propellers may be configured to provide thrust to move the device 1300 in the body of water 102. In a second configuration, the propellers may be configured to capture energy from a moving body of water. In a third configuration, one or more of the propellers may be configured to provide thrust to move the device 1300, while one or more different propellers may be configured to capture energy (e.g., motion energy).

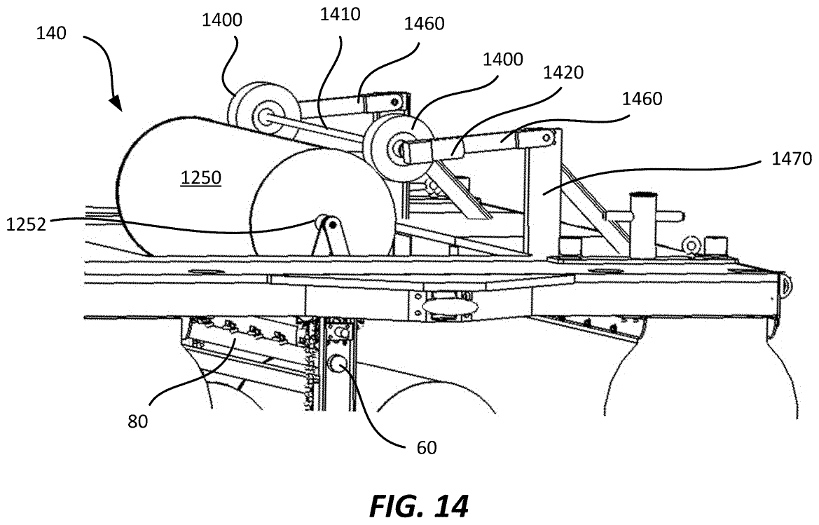

FIG. 14 illustrates an exemplary support assembly and rearing containers for the automated device for cultivating marine species, where the support assembly includes a device for rotating the containers. In FIG. 14, the device for rotating the containers is in an engaged configuration. FIG. 14 illustrates an example of the assembly 140 that utilizes the containers 1250 (e.g., growth containers, rearing containers) that are substantially cylindrical in shape. In this embodiment, each of the containers 1250 is supported along a central axis 1252 of the container 1250 and is free to spin about that axis. In some implementations, when the container 1250 reaches a specific point while travelling around the frame 60 (e.g., when the container 1250 reaches top dead center), an outer surface of the container 1250 comes in contact with one or more drive wheels 1400. The drive wheels 1400 may cause the container 1250 to rotate about its central axis 1252. The weight of the drive wheels 1400 may be enough to cause the container 1250 to rotate as the container 1250 moves along the frame 60. The drive wheels 1400 are mounted to a common drive shaft 1410 that is driven by a motor/gearbox 1420 that is attached to one of the repositionable arms 1460. The repositionable arms 1460 are coupled to support structure 1470. When the drive wheels 1400 rotate the container 1250, water may be emitted from the spray rail 80. This combination of water spray and rotation causes debris and marine fouling that has settled on the marine species, such as oysters, to become dislodged and removed, thereby cleaning the marine species in the containers 1250, which improves the conditions for growing the marine species. The drive wheels 1400, the shaft 1410, the motor 1420 and/or the repositionable arms 1460 may be part of means for rotating the containers.

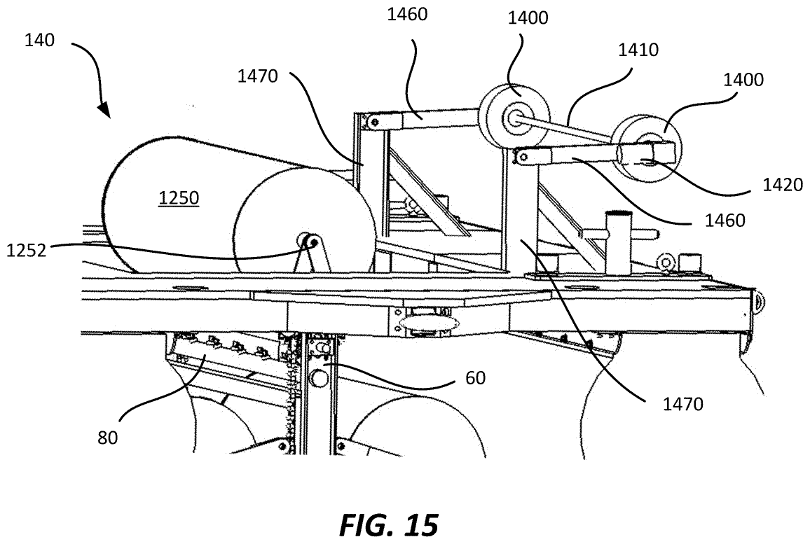

FIG. 15 illustrates the same example of the assembly 140 where the device for rotating the containers is in a disengaged configuration. FIG. 15 illustrates the repositionable arms 1460 rotated about the support structure 1470 to improve human access to the container 1250. In this position (e.g., disengaged position, disengaged configuration) it is also possible to remove the container 1250 from the device 100 for a variety of purposes, such as culling, harvesting, and replenishing. When the access to the containers 1250 is no longer needed, the repositionable arms 1460 may be rotated so they will engage with the containers 1250 as they are rotated around the loop and perform the rotation of the container 1250 while spraying it with water from below to clean the marine species, such as oysters. The repositionable arms 1460 may be moved manually or automatically through a device that can rotate the repositionable arms 1460. In the instance of automatically moving the repositionable arms 1460, a motor and/or a gearing device may be coupled to the repositionable arms 1460. A control device and/or computing device may be used to control the movement and/or rotation of the repositionable arms 1460.

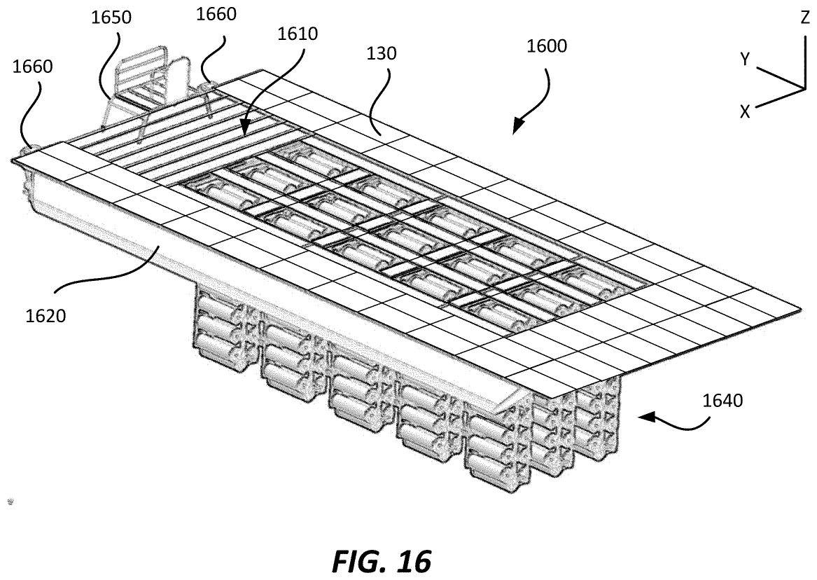

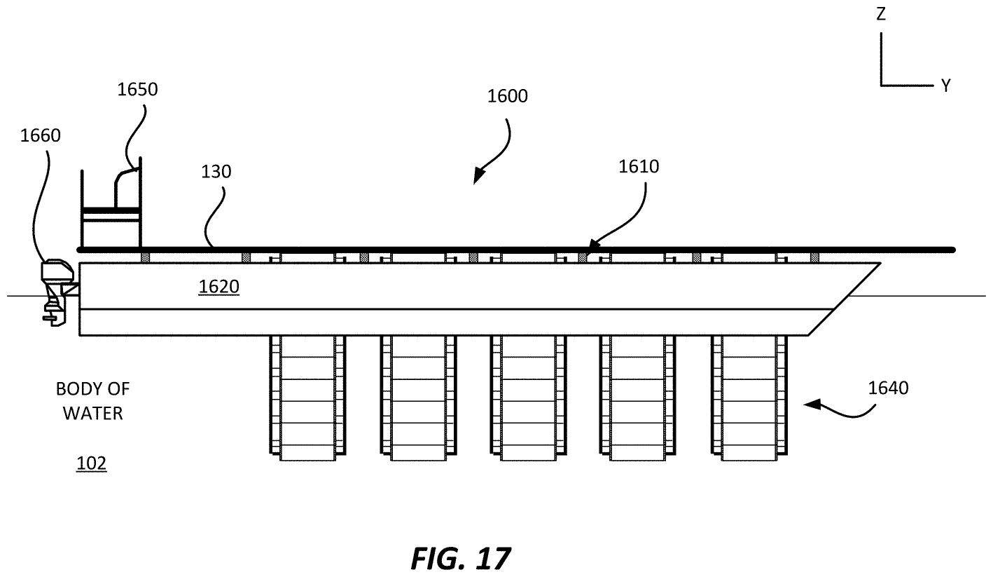

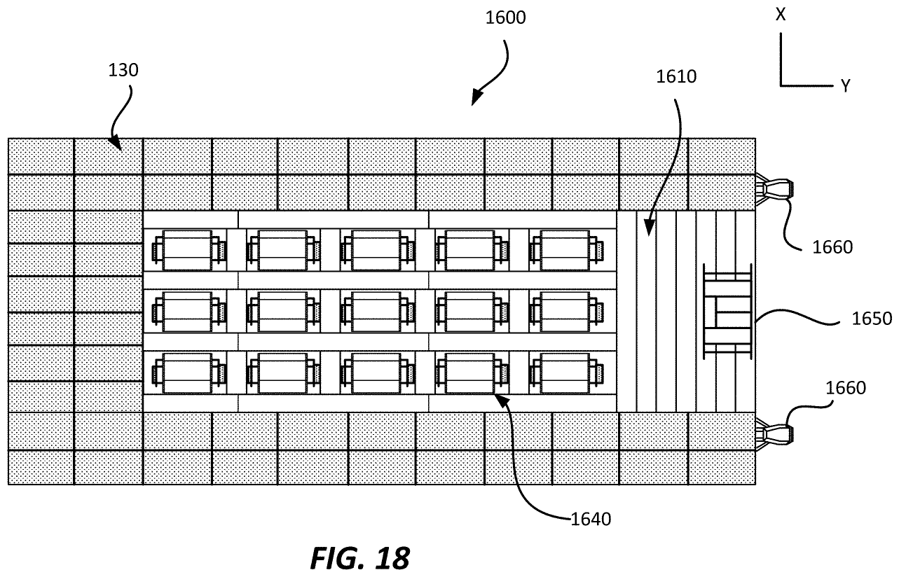

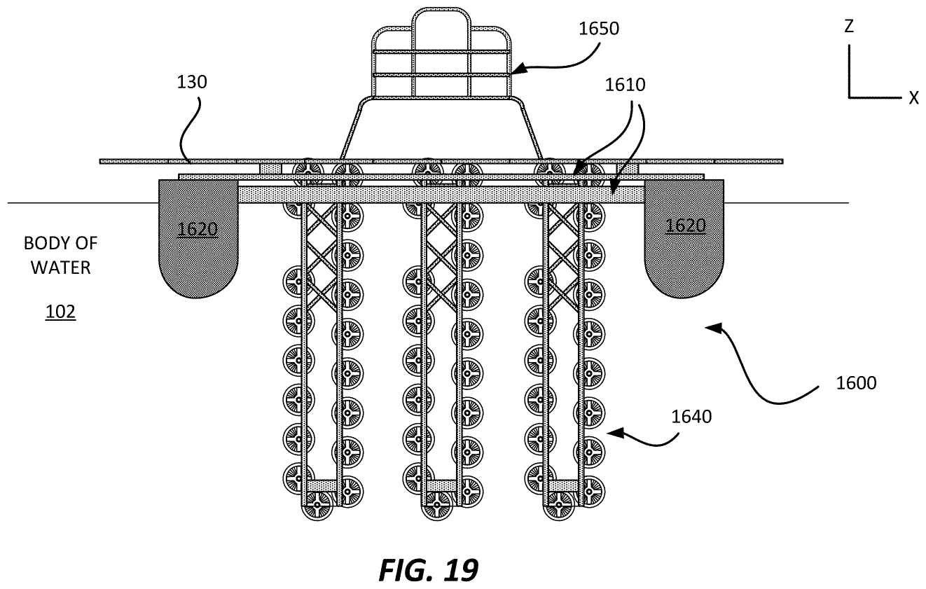

FIGS. 16-19 illustrate another example of a device 1600 that is configured to provide automated harvesting of marine species. The device 1600 may be implemented as a platform (e.g., floating platform). In some implementations, the device 1600 may be implemented as part of a vessel, a ship, a catamaran and/or a water borne vehicle.

As shown in FIGS. 16-19, the device 1600 includes a structure 1610, one or more buoyancy devices 1620 (e.g. buoyant float, first buoyancy device, second buoyancy device), one or more panels 130, and one or more assemblies 1640 (e.g., first assembly, second assembly). As will be further described below, marine species, such as oysters, may be cultivated (e.g., grown) in the one or more assemblies 1640. More specifically, marine species may be cultivated in one or more containers (e.g., 150, 1250) of the assemblies 1640. The assembly 1640 may be any of the assemblies described in the disclosure, such as for example, the assembly 140 as described in FIGS. 3, 10 and/or 12. The buoyancy devices 1620, the panels 130 and the assemblies 1640 are coupled to the structure 1610. The structure 1610 (e.g., support structure, vessel structure) may include one or more frames, beams, joints, and/or compartments that provide structural support for the device 1600.

FIGS. 16-19 illustrate one example of a structure 1610 for the device 1600. However, different implementations may provide a structure 1610 with different shapes and/or sizes. In addition, different implementations may use different materials for the structure 1610.

The one or more buoyancy devices 1620 are means for providing buoyancy for the device 1600. A buoyancy device 1620 may have the same shape, a similar shape or a different shape than another buoyancy device 1620. One or more of the buoyancy devices 1620 may be an inflatable buoyancy device. In some implementations, the buoyancy devices 1620 are configured in such a way that at least part of the assemblies 1640 are submerged in the body of water 102. For example, the size, shape, configuration, material(s) and/or position of the buoyancy devices 1620 may be selected so that part of the assembly 1640 is submerged in the body of water 102 while other parts of the assembly 1640 are above the body of water 102. Different implementations may include a different number of assemblies 1640. The device 1600 may include a plurality of assemblies 1640 that are arranged in rows and/or columns of assemblies 1640.

The panels 130 (e.g., first panel, second panel, third panel) are coupled to the structure 1610. The panels 130 may include a panel frame and solar panels for harvesting energy (e.g., solar energy), which can be used to provide power for the device 1600. Thus, the panels 130 may provide a source of energy (e.g., renewable energy) for the device 1600. The panels may be means for providing and/or harvesting solar energy. The solar panels may include photovoltaic solar panels. The solar panels may be coupled to an energy storage device (e.g., battery), a computing device (e.g., controller) and/or any other device that may operate on electric power. Each of the panels 130 may be moveable relative to the structure 1610. For example, each panel 130 may rotate about a point of the structure 1610; each panel 130 may slide along the structure 1610; each panel may pivot about the structure 1610; or combinations thereof. Different implementations may include a different number of panels 130.

The device 1600 also includes propellers 1660. The propellers 1660 are configured to move the device 1600 in a body of water. The propellers 1660 may be configured to operate in a similar way as the propellers (1302, 1304) of FIG. 13. The propellers 1660 may include a vessel motor.

The device 1600 may also include a standing structure 1650 configured for a person to stand on. The standing structure 1650 may be use by one or more people to stand on the device 1600. The standing structure 1650 may be coupled to the structure 1610. The standing structure 1650 may include one or more frames, beams, joints, and/or parts. It is noted that FIGS. 16-19, for the purpose of clarity, do not illustrate all the components and/or parts of the device 1600. As such, the device 1600 may include any of the designs, configurations, components, parts and/or functionalities that are described in the disclosure.

Having described several different components of the device (e.g., 100, 1300, 1600), a controller or computer device that is capable of controlling the device (e.g., 100, 1300, 1600) and/or components of the device (e.g., 100, 1300, 1600) will now be described below.

### Exemplary Controller for Device

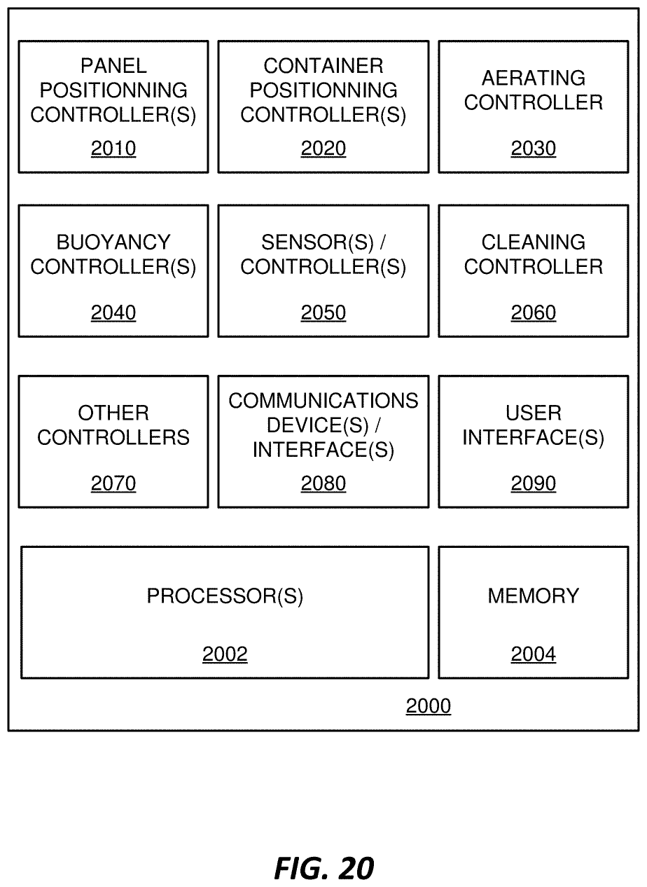

FIG. 20 illustrates a conceptual illustration of the functionalities of a controller 2000 for the device 100 and/or the device 1300. Configurations, functions, capabilities, operations and/or components that are described for the device 100 may also be applicable to the devices 1300 and/or 1600. In some implementations, the controller 2000 is implemented within the computing device 1100. In some implementations, the controller 2000 is computing device 1100. The controller 2000 may be used to perform automated operations of the device 100. In some implementations, there may be several controllers 2000 that may be located in different locations of the device 100. In some implementations, the controller 2000 is a conceptual example of the computing device 1100 described in FIG. 11. The controller 2000 may be implemented as hardware (e.g., processor, die, integrated device), software (e.g., non-transitory processor readable medium), and/or combinations thereof, in one or more devices (e.g., processor, chip, computer, tablet, mobile device).

As shown in FIG. 20, the controller 2000 includes one or more processors 2002, one or more memory storage 2004, one or more panel positioning controllers 2010, one or more container positioning controllers 2020, one or more aerating controllers 2030, one or more buoyancy controllers 2040, one or more sensors controllers 2050, one or more cleaning controllers 2060, one or more other controllers 2070, one or more communications devices 2080, and/or one or more user interfaces 2090. In some implementations, the above functions may be implemented in one or more controllers, devices, dies and/or integrated devices.

The processor 2002, the memory storage 2004 and/or combinations thereof, may be configured to process or perform operations with the one or more panel positioning controllers 2010, one or more container positioning controllers 2020, one or more aerating controllers 2030, one or more buoyancy controllers 2040, one or more sensors controllers 2050, one or more cleaning controllers 2060, one or more other controllers 2070, one or more communications devices 2080, and/or one or more user interfaces 2090.

The one or more panel positioning controllers 2010 are configured to control the operation of the panels 130. The one or more container positioning controllers 2020 are configured to control the operation of the assembly 140, the container frame 52 and/or the container (e.g., 150, 1250). The one or more aerating controllers 2030 are configured to control the operation of the aerating device (e.g., motor 192, blower 190). The one or more buoyancy controllers 2040 are configured to control the operation of the buoyancy device 120. The one or more sensors controllers 2050 are configured to control the operation of one or more sensors (e.g., 1110). In some implementations, controlling the operation of a sensor may include receiving readings and/or measurements from the sensor. The one or more cleaning controllers 2060 are configured to control the operation of a cleaning device (e.g., motor 182, pump 180). In some implementations, the one or more cleaning controllers 2060 may be configured to control whether the repositionable arms 1460 are in an engaged configuration (as described in FIG. 14) or a disengaged configuration (as described in FIG. 15). Other controllers 2070 may be configured to control the operation of other components and/or devices for the device 100. For example, the anti-theft device 1120 may be controlled by the other controllers 2070. How power from the panels 130 and/or the propellers 1302 is stored and/or used by components of the device 100 may be controlled by the other controllers 2070. In some implementations, the other controllers 2070 may be configured to control the propellers 1302, 1304 and/or 1660. Thus, the other controllers 2070 may control the propulsion of the device 100. In some implementations, a locking device 400 may be controlled by the panel positioning controllers 2010. The communication devices 2080 may include different devices and/or interfaces to communicate with different devices (e.g., sensors) and/or components. The communication devices 2080 may include a bus interface, a wired interface, wireless interface (e.g., Wireless Fidelity (WIFI), Bluetooth, radio, cellular, etc. . . . ), and/or an optical interface.

The user interfaces 2090 allow an operator to control and monitor the operation of the device 100 locally and/or remotely. For example, the user interfaces 2090 may allow an operator to remotely control the device 100. The user interfaces 2090 may also allow an operator to remotely control devices (e.g., sensor, camera, antenna) coupled to the device 100. However, it is noted that the device 100 may operate autonomously. Thus, many of the operations described in the present disclosure may be performed without input from a human and/or the presence of a human at the device 100.

One or more of the components, processes, features, and/or functions illustrated in FIGS. 1-3, 4A-4C, and/or 5-20 may be rearranged and/or combined into a single component, process, feature or function or embodied in several components, processes, or functions. Additional devices, elements, components, processes, and/or functions may also be added without departing from the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The disclosure describes various materials, components and/or parts for coupling objects together. However, it is noted that other materials, components and/or parts may be used to couple objects together. The term “about ‘value X’”, or “approximately value X”, as used in the disclosure shall mean within 10 percent of the ‘value X’. For example, a value of about 1 or approximately 1, would mean a value in a range of 0.9-1.1.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Any of the above methods and/or processes may also be code that is stored in a computer/processor readable storage medium that can be executed by at least one processing circuit, processor, die and/or controller. For example, the controller may include one or more processing circuits that may execute code stored in a computer/processor readable storage medium. A computer/processor readable storage medium may include a memory (e.g., memory die, memory in a logic die, memory controller). A die may be implemented as a flip chip, a wafer level package (WLP), and/or a chip scale package (CSP).

Those of skill in the art would further appreciate that the various illustrative logical blocks, modules, circuits, and algorithm steps described in connection with the embodiments disclosed herein may be implemented as electronic hardware, computer software, and/or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the disclosure described herein can be implemented in different devices and/or systems without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

1. An apparatus for cultivating marine species, comprising:
means for supporting the apparatus over a surface of the water;
means for providing water permeable containers for holding marine species; and
means for moving the water permeable containers so that debris may be flushed from the water permeable containers.

2. The apparatus of claim 1, wherein the means for moving the water permeable containers comprises means for moving the water permeable containers above the water surface to provide time to allow the marine species to dry out.

3. The apparatus of claim 1, wherein the water permeable containers include a mesh comprising a metallic mesh and/or a non-metallic mesh.

4. The apparatus of claim 3, wherein the mesh is of sufficient strength to prevent predators from gaining access to the interior of the water permeable containers.

5. The apparatus of claim 3, wherein an open area of the mesh is sized to prevent the marine species from passing through the opening.

6. The apparatus of claim 1, wherein the water permeable containers can be easily removed individually from the apparatus.

7. The apparatus of claim 1, wherein the means for moving the water permeable containers includes means for rotating the water permeable containers to cause the marine species to be flipped over.

8. The apparatus of claim 1, further comprising means for capturing energy.

9. The apparatus of claim 8, wherein the means for capturing energy includes photovoltaic panels.

10. The apparatus of claim 8, further comprising means for moving the photovoltaic panels to provide access to the water permeable containers.

11. The apparatus of claim 8, wherein the means for capturing energy includes components for converting water current into energy.

12. The apparatus of claim 8, wherein the captured energy is configured to be used to power a water pump to flush debris from the marine species.

13. The apparatus of claim 8, wherein the captured energy is configured to be used to power a blower to disperse air below the apparatus.

14. The apparatus of claim 8, wherein the captured energy is configured to be stored in a battery in the event that the power is in excess to the needs of the apparatus.

15. The apparatus of claim 1, wherein the means for moving the water permeable containers is configured to move the water permeable containers into one or more positions so that waste that has collected can be flushed out.

16. The apparatus of claim 1, further comprising means for rotating the water permeable containers.

17. The apparatus of claim 1, further comprising means for dispersing air below the apparatus to increase the level of dissolved oxygen.

18. A device for cultivating marine species, comprising:
a structure;
a buoyancy device coupled to the structure;
a panel coupled to the structure, wherein the panel is configured to capture solar energy; and
an assembly coupled to the structure, the assembly comprising:
a support frame; and
a container configured to store marine species, wherein the container is configured to be moveable.

19. The device of claim 18, wherein the container is further configured to be rotatable.

20. The device of claim 18, further comprising a propeller configured to provide thrust to move the device in a body of water.

21. The device of claim 18, further comprising a propeller configured to capture motion energy from the movement of water in the body of water.

22. The device of claim 18, wherein the buoyancy device is configured to help the device float in a body of water.

23. The device of claim 18, further comprising an energy storage device configured to store solar energy captured by the panel.

24. The device of claim 18, wherein the container includes a water permeable container.

25. The device of claim 18, further comprising a cleaning device configured to remove debris from the container, wherein the cleaning device includes:
a pump; and
a motor that drives the pump.

26. The device of claim 25, wherein removing debris from the container includes:
using the pump to pump water from a body of water; and
using a spray nozzle to direct the pumped water towards the container.

27. The device of claim 18, further comprising an aerating device configured to provide oxygen in an area of a body of water that includes the container, wherein the aerating device includes:
a blower; and
a motor that drives the blower.

28. The device of claim 18, wherein the assembly further comprises:
a first sprocket coupled to the support frame;
a first motor coupled first sprocket; and
a first chain coupled to the first sprocket and the container.

29. The device of claim 18, wherein the device is implemented as a floating platform.

30. The device of claim 18, wherein the device is implemented as part of a vessel, a ship, a catamaran and/or a water borne vehicle.
